(19) United States
(12) Patent Application Publication
(10) Pub. No.: US 2012/0247189 A1
(43) Pub. Date: Oct. 4, 2012

(54) METHOD OF MEASURING THE SIZE OF A LEAK IN A PNEUMATIC AIR CIRCUIT AND A RELATED DEVICE

(75) Inventor: Geoff Finlay, Brampton (CA)

(73) Assignee: EUTECTIC SOLUTIONS INC., Mississauga (CA)

(21) Appl. No.: 13/433,019

(22) Filed: Mar. 28, 2012

Related U.S. Application Data
(60) Provisional application No. 61/469,347, filed on Mar. 30, 2011.

(51) Int. Cl. G01M 3/24; G01M 3/28

(52) U.S. Cl. 73/40.5 A; 73/40.5 R

(57) ABSTRACT

A leak detecting device comprising: a housing with gas inlet, a gas outlet, at least one pressure gauge for measuring the gas pressure supplied to the tested system, at least one flow meter for measuring the flow of the gas from the device to the tested system, at least one flow control valve to vary the gas flow through the device, an operating valve for permitting the flow of the gas from the device into the system to be tested. When said device is utilized, the inlet is attached to a pressure generating apparatus, the outlet is attached to the system to be tested, said pressure gauge showing the system testing pressure, and the flow meter indicates the flow of the gas through the device and the system being tested, thereby indicating the existence of any leakage and quantifying the total size of the leakage.

### CROSS-REFERENCE TO RELATED APPLICATIONS

This application claims priority to U.S. Provisional Application No. 61/469,347 filed on Mar. 30, 2011, the entire contents of which are incorporated herein by this reference.

### FIELD OF THE INVENTION

This invention relates to a device and method used for determining the size of an air leak in a pneumatic circuit and for establishing the effectiveness of an ultrasonic leak detection device.

### BACKGROUND OF THE INVENTION

Compressed air is required for stopping a vehicle as well as allowing it to move. An air brake system that has leaked all of its compressed air, will by default, lock up all of the wheels. Generally, the system needs to be charged to 60 psi or higher to unlock the wheels.

An air brake system's operating pressure range is generally between 90 and 125 psi. When the system pressure drops to the lower end of the range, it is topped up by the compressor and associated valving. It's normal for air pressure to fluctuate in these systems, it's also considered normal to have a certain amount of leakage, understanding that it's not possible to contain air pressure indefinitely in any system without some leakage.

It follows very small leaks will not stay as small leaks indefinitely. Eventually some of them become large enough that the vehicle will not be able to move (after a period on not running) The compressor must then replenish the system pressure high enough (over 60 psi) so the parking (or spring) brakes will come off and the wheels are allowed to turn freely.

Added to the issues created by leakage is that an expensive compressor (designed to service a specific sized system), will have to perform additional work beyond its expected duty cycle. This has the potential to create a catastrophic (very costly) premature compressor failure. Of course when the compressor is under load, the fuel consumption and the production of greenhouse gases are further increased.

Additionally, a vehicle that has completely ran out of air will have to idle for sufficient amount of time to replace the lost air, further increasing its fuel consumption and greenhouse gas production.

Heavy duty truck technicians spend many hours simply trying to find leaks. The technician consumes many hours while trying to track them down. Currently there are two preferred methods to find leaks.

Even in 2010, the most common method is using a squeeze bottle filled with soapy water which the technician sprays on the areas of the system that are suspect and available. Often, large areas of the system are out of sight and reach, so the technician takes on the job knowing that his/her success rate is limited. This method takes about 4 hours on a typical tractor.

Even if the technician finds and repairs a leak, the only way to know if there are no other leaks is by filling the system and waiting (possibly) overnight to determine the effectiveness of the repair.

In the early 1990's, ultrasonic leak detectors (ULD) were introduced, to “listen” to the sound of a leak. Unfortunately the performance varies from unit to unit and also between manufacturers. The product was considered unreliable.

The actual problem with the product is that inexpensive ultrasonic leak detectors cannot locate many small leaks from more than a very short distance. On the other hand, even the most expensive versions have some limitations. If the leak is smaller than a given size, but the approximate location is known, the leak can possibly be identified. However if the leak location is not known, that leak will likely not be identified. Success is also dependant on the type, shape & direction of the leak; all factors that cannot be controlled.

Regardless of the size of the leak, if the leak size is known it will point the technician in one direction or the other to appropriately address the leak and not waste time trying to locate leaks that are either not worth finding or virtually impossible to find.

In today's transportation industry, scheduling service time is more important than ever.

Unscheduled down-time is more costly than ever with fines being levied for delivery tardiness by many corporations. Thus knowing the status of air brake leaks is one step towards eliminating this down-time.

Today's heavy trucks, buses & emergency vehicles may use their compressed air supplies for much more than stopping the vehicle. There are more air driven systems such as foam machines, cooling fan control & gear shift controls, air ride seats, and some types of pumps. Buses have air driven doors and ramps and so on. Air suspensions and pneumatic starter motors are common. Fire trucks may drive aerial ladders/locks and have a compressed air supply line in the ladder for rescue equipment. Imagine a fire truck unable to answer a call while waiting for a compressor to unlock the brakes.

### DISCUSSION OF PRIOR ART

Referring to U.S. Pat. No. 5,808,909 to Rees granted Sep. 15, 1998 it states that AAR standard, S.486 specifies the use of a flow meter, that is typically a variable orifice floating ball device, visually observable by the operator for measuring the air flow rate in the railroad car brake system. In the United States, the testing procedure is conducted in accordance with the testing system standard S.486, by the Association of American Railroads (AAR) and the United States Department of Transportation, Federal Railway Administration (FRA). Standard S.486 particularly mentions a “device handle” utilizing a rotary valve that is positioned by the operator in any one of a multiplicity of mutually exclusive positions. Thus, for example, if the device handle is in position 1, it will cause release and charging of the vehicle brake system. Moving it from position 1 to position 2 reduces the capacity to charge by positioning the internal rotary valve so that the air flows through a smaller orifice. Further moving it to positions 4, 5, or 6 cause air to be released from the brake pipe. In each case the movement will close the port that is connected and open the next one. Positions 1 and 2 cause air from the regulating valve to flow into the brake pipe. Positions 4 through 6 cause air to be exhausted from the brake pipe through successively larger orifices, thereby releasing the air at accordingly greater rates. When the device is being tested, and during the device handle movements, as provided by S.486, pressure, air flow and time measurements are taken at the appropriate intervals to ensure that the system is working properly. S.486 also specifies a ⅜″ bypass valve cock that causes air to be exhausted from the brake pipe, but at a faster rate than provided by any of the rotary valve positions. The valve cock is separate from the device handle and is therefore not mutually exclusive with the positions of the rotary valve and may be operated independently as provided by S.486.

Thus, the teaching of that patent substitutes for this device from the S.486 standard a commonly found volumetric, temperature compensated, electronic flow measuring means, such as flow meter 28 that is located on the manifold 19 between the air intake orifice 50 and the air passages that are connected to the conduit hoses 20. Like the pressure transducers 40, the flow meter 28 may be turned on and off by the controller 11 as it is needed, reducing power usage and providing reliable flow measurement that can be evaluated by the computer. Electronic mass flow meters may also be used. Standard S.486 also specifies timing certain functions that are customarily done with a stop watch. All timing functions in the invention are carried out at a high level of accuracy and repeatability by using the internal clock of the microprocessor 17. No mention however is made regarding a simple portable device which may be used along with an ultrasonic leak detector to manage leaks in trucks and rolling stock.

Liao (U.S. Pat. No. 5,705,737)

Liao describes a pressure leakage detector particularly useful for detecting leakages occurring in closed systems of an automobile. The detector includes a primary pressure gauge 10 which is connected to an air compressor p, and a secondary pressure gauge 20 connected to the primary pressure gauge 10 by a valve 30. The secondary gauge 20 is adapted to connect to a closed system or sealed container on which leakage detection is to be performed. Pressure regulator 13 is connected between an inlet port 14 of primary gauge 10 and air compressor p providing manual control to the pressure flowing into the primary gauge 10. A container to be tested may be connected to the primary gauge 10 through valve 12. Valve 23 disposed at the secondary gauge 20 is provided for the purpose of manually operated pressure relief. Valve 22 also disposed at the secondary gauge 20 may be connected to a hose 221 to connect to a cooling system or fuel tank. The testing method begins with valve 30 between the gauges set to closed and compressed air enters from air compressor p, through pressure regulator 13 into the primary gauge 10 until a desired level is set. With valve 22 closed, valve 30 between the gauges is opened allowing both gauges to reach the same pressure level. Valve 22 is opened and the gauges are allowed to return to their same levels. Valve 30 is closed, and secondary gauge 20 is monitored for a change in pressure. A drop in the reading on the secondary gauge 20 indicates a leakage on the system that is detected. Once detection is complete, pressure may be relieved by opening valve 23.

Liao describes the use of two pressure gauges to measure air pressure in different regions of a leak testing device. When the pressure is equalized in the system, a valve is closed connecting the two gauges with each other, leaving the first gauge to show the previously equalized air pressure, and the second gauge to indicate the air pressure of the device being tested. If there is a leak in the device being tested, the second gauge will indicate a lower pressure than the first gauge. Again the teaching does not include using flow meters or cooperative use with an ULD.

Crane (U.S. Pat. No. 7,054,777)

Crane describes a test device and method for testing a rail car brake system. The device includes a supply of test air 16 connected to a brake pipe of the brake system being tested. The test air passes through a pressure regulator 36 to reduce the test air pressure to the particular pressure required by the brake test. Connected to the pressure regulator 36 is valve manifold 18 including a set of valves and associated orifices of different size. Depending on the particular positions of the five valves, the test air is either supplied to the brake pipe of the brake system being tested vented to atmosphere 38 or held in a static condition. Vent valve 40 may also be used for rapidly venting test air to atmosphere during specific portions of the brake test. Pressure sensors 20, 24 and a flow rate meter as shown in FIG. 1 to measure the pressure and flow rate of the test air during various portions of the brake test.

Oswald (U.S. Pat. No. 3,813,922)

Oswald describes an air leak detector in which a regulated pressure air source is coupled to a container (particularly a battery container) under test through both an open-close valve and a flow meter having an element moved by slight air flow. A source 12 of air under pressure is connected through a line 13 to a container 11 to be tested for leaks. An open-close valve 16 and a flow meter 17 with element 18 which moves from a zero position in response to air flow are interposed in line 13. A pressure regulating valve 15 may also be disposed in line 13 at the source 12 to stabilize the supply of air to the system. A detector 20 watches the element 18 and triggers a signal when the element 18 moves away from a zero position. The test begins by regulating the air pressure in the container, and then valve 16 is opened. If there is a leak in the container, the element 18 will be displaced causing the detector 20 to trigger the signal. Alternatively, the flow meter 17 may be of the type in which the element 18 is a ball fitted in an inverted hollow frustum 22 through which the flow is detected is from the bottom to the top. Air flow moves the ball 18 up the frustum 22 a distance proportional to the flow rate. By utilizing appropriate ball weights and sizes, very low flow rates can be sensed. A testable flow rate of0.2 standard cubic feet of air per hour (scfh) is described using this method.

Oswald describes a leak testing device comprising one flow meter. A device to be tested is connected by an air line to the flow meter which in turn is connected by a line to a source of pressurized air to fill the test device. When the test device is fully pressurized, the flow meter may indicate small leaks, down to 0.2 standard cubic feet of air per hour (scfh). However, Oswald does not disclose using two flow meters in series to measure air flow when both pressurizing and evaluating a ULD test device.

None of the references disclose testing ultrasonic leak detectors using flow meters, nor do they describe testing any type of device or system by slowly opening a flow control valve of a flow meter to determine how the device being tested responds. Further, none of the devices in the prior art provide a simple portable device designed for this purpose.

It is therefore a primary object of this invention to provide a method of testing a pneumatic circuit to determine the volume of any existing leak.

The equipment addresses the high cost of time wasted by every commercial truck, bus, train, and heavy equipment mechanic while trying to locate and repair compressed air leaks. While commercial equipment exists to accurately measure system recovery times (for certification purposes), this type of equipment does not specifically address the size of the system's leaks.

It is yet another object of the invention to provide a device for carrying out the method.

It is a further object of the invention to provide a device for evaluating the capability of an ultrasonic leak detecting testing device along with a method of using the device for evaluating the ULD device.

Further and other objects of the invention will become apparent to those skilled in the art when reading the following disclosure of the invention including the summary of the invention, claims and the detailed description of the preferred embodiments illustrated herein.

### SUMMARY OF THE INVENTION

There is disclosed a method of measuring the size of a leak in a pneumatic system and a related device to carry out the method. The equipment is primarily aimed at air brake systems on commercial heavy duty vehicles, but can be used on any compressed air storage system to measure the size of an unknown leak.

Further, the equipment can be used to measure the sensitivity and accuracy of any ultrasonic leak detector (ULD), establishing precisely the minimum size leak it is capable of detecting in terms of leak size, distance and direction.

By establishing the exact size of the leak (or leaks) and comparing the leak size with the best potential performance of the ULD, the appropriate approach to locating the leak is much clearer. Using this method, the heavy equipment mechanic will eliminate time wasted on leaks that are impossible to find with the ULD.

The present invention changes the entire approach to air brake leaks in several ways: First it educates the mechanic by putting an actual number in lpm (litres per minute) to the size of the leak or total leakage. Next it shows the mechanic in unmistakable terms the total leakage before beginning the job, further, it points out whether there is one leak or multiple leaks.

Simply, a single leak that is greater than 1 lpm is generally audible from several feet. If a 1 lpm (or greater) leak is indicated and it cannot be detected by the human ear, there is usually more than one leak contributing. It must however be noted, that occasionally a very large leak can be inaudible to the human ear, even from close range. Many of these types of leaks can be found in the cab of the vehicle and masked by the direction of the leak and its surrounding “baffling”.

This new information determines the correct approach to the job. Using a modern ULD (ultrasonic leak device), the mechanic will perform a systematic diagnosis of the entire brake system, including the cab (controls, lines, seat, gauge etc) which could not be sprayed with soap. The total time spent to this point will be 20 to 30 minutes depending on the system's air capacity.

Even if the first pass is negative, the actual leak size will be displayed on the flow meters continuously. Unlike the old hit or miss method, the guesswork and judgement are obviated. If there is “no leak at this time” the tool will prove it.

Note that the current invention has the ability to emulate any size leak via its built in test port to verify the ULD's capability, adding confidence in the ULD to the process.

As the mechanic now takes a closer look, the leaks will be located. The superhetrodyne circuitry of new generation ULDs, will locate an air leak as small as 0.1 lpm from 2-3 feet. Even smaller leaks can be located from closer in.

The leaks will be repaired and the device of the current invention will be used to measure the remaining (if any) leakage. There is no guesswork required. Even if a small amount of leakage remains, all involved will know how small it is and if it's worth spending time finding it.

A leak size over time graph is also useful. Consulting the graph, the timeline of a leak from 120 psi to 80 psi then 60 psi then zero can be predicted.

The total time to hook up the device of the current invention, locate the leaks then retest for final results will vary from 30 to 40 minutes. This predicts the time required and reduces the potential diagnostic time from 4 hours to less than 1 hour. Further, the results are guaranteed and both the mechanic and the truck owner are winners.

Note that repairing air brake leaks reduces compressor cycle times, protecting it from premature failure, improves fuel consumption, less engine load and reduces harmful exhaust emissions, as the engine is not working harder to drive the compressor longer.

Further, using the equipment on a regularly scheduled basis (particularly on emergency vehicles), required repairs can be anticipated and scheduled in a more controlled fashion.

According to a primary aspect of the invention there is provided a leak detecting device comprising a housing with gas inlet and gas outlet, at least one pressure gauge for measuring the gas pressure supplied to the tested system, at least one flow meter for measuring the flow of the gas from the device to the test system, at least one flow meter including a flow control valve to vary the gas flow through the device, and an operating valve for permitting the flow of the gas from the device into the system to be tested, wherein when said device is utilized, the inlet is attached to a pressure generating apparatus such as a compressor, the outlet is attached to the system to be tested, said at least one pressure gauge showing the system testing pressure, and the at least one flow meter indicating the flow of the gas through the device and the system being tested, indicating the existence of any leak and quantifying the total size of the leak.

Preferably, the leak detecting device has at least two flow meters in series wherein a first flow meter measures high flow of gas through the device preferably between 0.3 lpm to 3 lpm and a second flow meter measuring low flow of gas through the device preferably between 0.02 lpm to 0.3 lpm, wherein the volume of said leak can be indicated by one of said at least two flow meters.

Preferably, the leak detecting device has a first pressure gauge located between the gas inlet and the said at least two flow meters; and a second pressure gauge between the operating valve and the gas outlet from the device, the first pressure gauge measuring the pressure provided by the pressure generating apparatus and the second pressure gauge measuring the pressure in the tested system following the opening of the operating valve. During the testing procedure, the pressure generating apparatus being attached to the gas inlet to the device, the tested system being attached to the gas outlet from the device, thereafter the operating valve is opened and the pressure gauges are stabilized, thereby the flow meters indicating the total size of the leakage of the system. The size of leak is most acceptable if both flow meters indicate zero.

Preferably, the leak detecting device is portable, and requires no electrical input.

According to still another aspect of the invention there is provided a method of measuring a gas leak in a pressurized system using a leak detecting device, said device comprising an inlet, an outlet, two pressure gauges, at least two flow meters and an operating valve, the method comprising the following steps:
a) Attaching the gas outlet of the device to the system being tested;
b) Attaching a gas pressure generating apparatus to the gas inlet of the device;
c) Optionally reading the gas pressure supplied into the device from the first pressure gauge;
d) Optionally adjusting the gas pressure supplied to the device based on the readings of the first pressure gauge;
e) Opening the operating valve to let the gas enter into the tested system;
f) Reading the system gas pressure on the second pressure gauge;
g) Allowing the pressure in the system to stabilize;
h) Reading the gas flow into the system indicated on the first -high flow meter;
i) reading the gas flow into the system indicated on the second -low flow meter;
j) comparing the flow readings from the flow meters to acceptable gas leak size values.

If the gas leak size is not acceptable, conduct further testing to locate the leak, using an ultrasonic leak detection device or the like, so the appropriate repairs can be made.

The device and the method of using said device can also be used to determine the effectiveness of ultrasonic leak detection device (ULD) by positioning said ULD adjacent the outlet from the device while varying the flow control. By varying the gas flow from minimal flow upward, the lower limit response of the ULD may be determined.

Optionally, the device has three gas flow meters, a first gas flow measuring the range of 0 to 50 lpm, second flow meter measuring 0.3 to 3 lpm and third flow meter measuring 0.02 to 0.3 lpm.

According to yet another aspect of the invention there is provided a leak detecting device as described above therein the gas outlet of the device is placed proximate an ultrasonic leak detecting device or the like; wherein the flow control valve is varied to permit a range of gas to flow through the gas outlet, indicated by said flow meters permitting testing of the sensitivity of said ultrasonic leak measuring devices or the like in sensing a leak, by setting the flow to a known value indicated by the flow meters, thereby the lowest response point of the ULD can be determined.

In a preferred embodiment said system is utilized for testing pneumatics circuits for transport trucks, trains, and other similar vehicles including fire trucks. To this end and according to another aspect of the invention there is provided a method of establishing the effectiveness of any ultrasonic leak detection device, said method comprising providing a pneumatic circuit as set out above also including the ability to simulate an air leak of predetermined value's wherein said circuit is charged with pressurized air up to a predetermined value. Using an ultrasonic leak detection device to determine the location of said leak in cooperation with said system which determines the value/volume of said leak.

In one embodiment said device is a portable device which may be battery operated and including a housing, a first pressure gauge, a second pressure gauge in series with said first pressure gauge, a first flow meter for indicating the pneumatic circuit pressure flow, a second flow meter for indicating the volume of the leak being tested if any, a pressure regulator provided in said circuit, wherein when the test circuit such as a pneumatic brake system of a transport truck is connected, operation of a ball valve will initially pressurize the circuit in a manner described above.

### BRIEF DESCRIPTION OF THE DRAWINGS

FIGS. 1 and 2 are perspective views of the housing for a leak detecting device illustrated in a preferred embodiment of the invention.

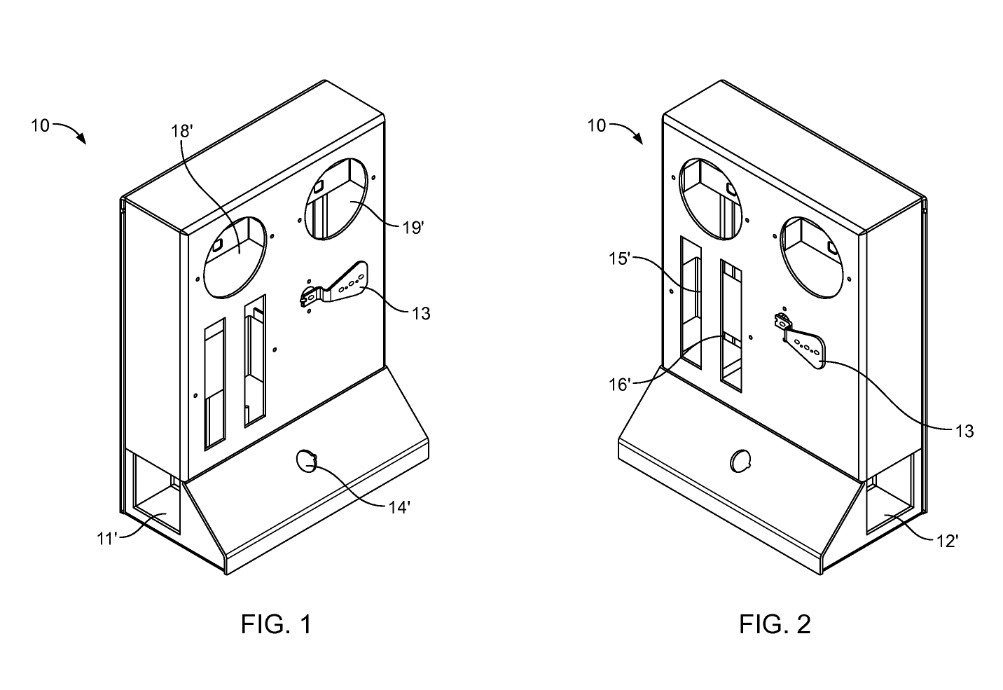

FIG. 3 is a front view of the device illustrated in FIGS. 1 and 2.

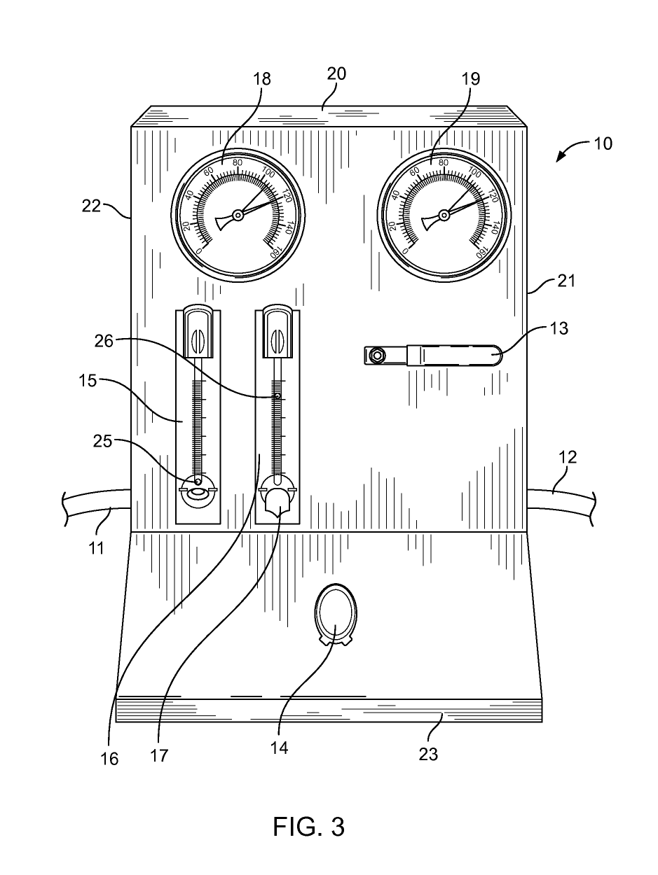

FIG. 4 is a flowchart for the pneumatic circuit embodied in the device illustrated in FIG. 3.

FIG. 5 is a schematic flow chart of the use of the device with an ultrasonic leak detector.

FIG. 6 is a front view of the second embodiment of the invention.

FIG. 7 is a flow chart of the pneumatic connections of the device of FIG. 6.

FIG. 8 is a schematic view of the connectors of the embodiment of the invention of FIG. 6

### DETAILED DESCRIPTION OF THE PREFERRED EMBODIMENTS

### The Operation of an Embodiment of the Invention

Hook up: the air line into the truck's dryer is removed at the dryer and the air brake solution test hose is hooked into the dryer. The shop's air supply is plugged into the air brake solution.

Set target pressure: using the pressure regulator, the target test pressure is set, usually 100 psi. This is reflected on the target pressure gauge.

Reset to bypass mode: the reset valve is cycled on/off to ensure the air brake solution is in its bypass mode. This bypasses the air flow meters to speed up the fill process.

The fill process: the lock 'n load lever is turned to the load position and the system begins to fill. As the air brake system begins to fill, its pressure is shown on the system pressure gauge.

At this point there is a wait time for the two pressure gauges to equalise. If the air brake system is empty it will take 7 to 10 minutes (depending on capacity) to fill the system.

Shift to airflow meters: as the system pressure reaches 90-95 psi (+/−2 psi) the internal pilot valve shifts circuits and the air flow meters are activated, both flow meter indicator balls (floats) will shoot to the top of the flow meters until the pressure gauges are almost equal. At this point air flow begins to slow down.

Reading the flow meters: when airflow slows down to 3 lpm the high flow meter ball will begin to drop. There will be at least 2 pauses of significant length (15 seconds or more) over the next few minutes, and then the ball will drop to a final reading, where it will remain.

The final value (lowest) is the equalized pressure reading which is lower than the actual leak size. The last (lowest) significant flow reading above the equalised pressure value is the actual size of the total leakage.

Very small leaks: the high flow meter will accurately read down to a leak of 0.2 lpm (which would be a very small & acceptable amount of leakage). If the total leakage is less than 0.2 lpm the high flow meter will bottom out and the low flow meter will begin to drop.

Any reading in the low flow meter's range is a very good result. If after the repair/s the low flow meter ball drops to zero, that's an excellent result, there is no leakage at all.

Leak size reference: as a reference, to put leak sizes into perspective. Using 20 us gallons as a system's capacity, a total leak size of 1.25 lpm will completely drain a system in 9 hours. A leak size of 0.25 will take 53 hours to completely drain the same system.

Referring generally to the figures there is illustrated the testing device 10 embodying the invention. According to yet another aspect of the invention both the system and method are carried out using a device for testing pneumatic brake circuits, said device comprising:
An air pressure regulator 14, controlling air pressure from 0 psi to 120 psi
A two-way ball valve 13—required to set target pressure
Two -air pressure gauges, measuring from 0 psi to 150 psi—18 to read targeted pressure 19 to read actual system pressure
An air flow meter 15 measuring from 0 lpm (litres per minute) to 50 lpm—to indicate system fill rate. This flow meter can be eliminated to reduce the cost of manufacturing.
An air flow meter 16 measuring from 0.05 lpm to 5 lpm—to indicate system leak rate
An appropriate housing 20
An air line 11 delivering shop air to the equipment—compressed air supply
An outlet pressure line 12 hooked between the equipment and the vehicle's air brake system.

Said system may be used to test air circuits for brakes with or without the assistance of a effective ultrasonic leak detector to assist the mechanic in completing the tasks on a priority basis.

The following method is used with the device embodying the invention:
a) Compressed air from the shop's compressor (125 psi min) is supplied to the equipment;
b) The outlet pressure line 12 is hooked between the equipment and the vehicle's air brake system;
c) The 2-way ball valve 13 is closed (lock position) and the air pressure regulator 14 will be adjusted to the desired test pressure. The target pressure gauge 18 will reflect this;
d) The ball valve's lever 13 is moved to the load position. Compressed air is directed into the system;
e) The system pressure 19 gauge will rise as the system is being pressurized;
f) The high (0-50 lpm) flow meter 15 will reflect the flow into the air brake system (over the measured range—initially “pinned” high);
g) The low flow (0.02-3 lpm) meters 17 indicators 26 will be “pinned” to the top of the meter;
h) As the system pressure approaches the target pressure, air flow will naturally be reduced. This will (first) be reflected in the high flow meter beginning to drop;
i) As the system pressure is very close to the target pressure, the low flow meters will begin to drop into range .i.e. below 3 lpm;
j) If the system has no leak, the system will fill to target pressure, wherein both air pressure gauges will read the same and both flow meter indicators will be at rest;
k) If the system has a leak over 3 lpm the low flow meter indicator 26 will not fall, indicating a large leak which will be indicated on the high flow meter 15. If the system has a leak between 0.2 lpm and 3.0 lpm it will be indicated on one of the flow meter;
l) If the system has a leak between 0.02 lpm and 0.2 lpm it will be indicated by the low flow meter 16.

Leak issues:

When an air brake system's pressure falls below 60 psi, the parking brakes are locked on. The vehicle must then be started so that the air compressor can “pump” the system above 60 psi so that the vehicle may be driven. (consider an emergency vehicle in this predicament). Constant uncontrolled air leaks cause the compressor to work harder, more often, leading to catastrophic, expensive failure. Additionally, the more often the compressor is under load, the more fuel the vehicle will use and more unwanted exhaust emissions will be produced. Further, vehicles with substantial leaks will require additional idle time following the start-up before they can be driven.

Many commercial vehicles use an air driven starter motor. This type of device requires 80 psi to crank the engine. A system that has fallen below 80 psi will not be able to start. An outside air supply is then required.

Leak size discussion:

There is no specific regulation covering actual leak size. The federal regulations discuss “reservoir recovery”. This only refers to the length of time the system takes to recover lost pressure from 85 psi to 100 psi during normal operation.

It's understood that a 1 lpm leak will appear to be slower to lose pressure in a larger capacity system than a smaller one. Since it's not possible to know the air capacity of every vehicle, the safest approach to measuring is using the size of the leak and an average system. Larger systems will take longer to lose pressure (and to recover) than smaller systems.

According to a traffic act regulation the pressure drop should not exceed:
(i) with the air brake system fully charged and engine stopped, air pressure drop shall not exceed,
(ii) with the service brakes released, two pounds per square inch in one minute, and
(iii) with the service brakes fully applied, three pounds per square inch in one minute.

However loosing 2 psi per minute the system starting with 120 psi will go to zero in about 60 minutes.

Compressed air in a tank:

Air brake systems always have at least 2 air tanks The primary or wet tank is used to collect moisture within the system that can be damaging to the rest of the system. Many vehicles have multiple tanks to support more axles and other systems such as air driven doors on some buses.

According to Boyle's Law, calculating the amount of air in compressed form requires multiplying the cubic feet of compressed air×pounds² inch absolute. Dividing this result×14.7 (atmosphere) provides the volume in cubic feet.

A (us) ten gallon pressure storage tank holds 1.336 cubic feet.

If it is pressurized to 125 psi the psia (125+14.7) will be 139.7 (psi+atmosphere) 1.336×139.7=186.639 divide by (atm) 14.7=12.696 cubic feet. 12.696 cubic feet=359.5 litres

A 1 litre per minute leak will completely empty the tank in about 6 hours.

The leak rate will not be linear. Pressure will be lost at a faster rate at higher pressures. To leak down to <60 psi will take about 33% of the 6 hours, depending on the type of leak.

The tool has 2 purposes:
1) To measure the size of a leak or multiple leaks in an air brake system.
2) To test/confirm the minimum size of leak that an ultrasonic leak detector can recognize and respond to.

Components:

There are 2×air pressure gauges 18,19 ranging from 0-150 psi. The system never exceeds 120 psi.

There are 2 or 3 simple (ball type) air flow meters to indicate the amount of air flow during each operation. The (lowest) low flow meter 16 incorporates a flow control valve 17.

There is 1 piston type (high pressure) pressure regulator 14, with a range of 0-120 psi.

There is a simple 2-way ball valve 13 that is used to isolate the tool from the air brake system.

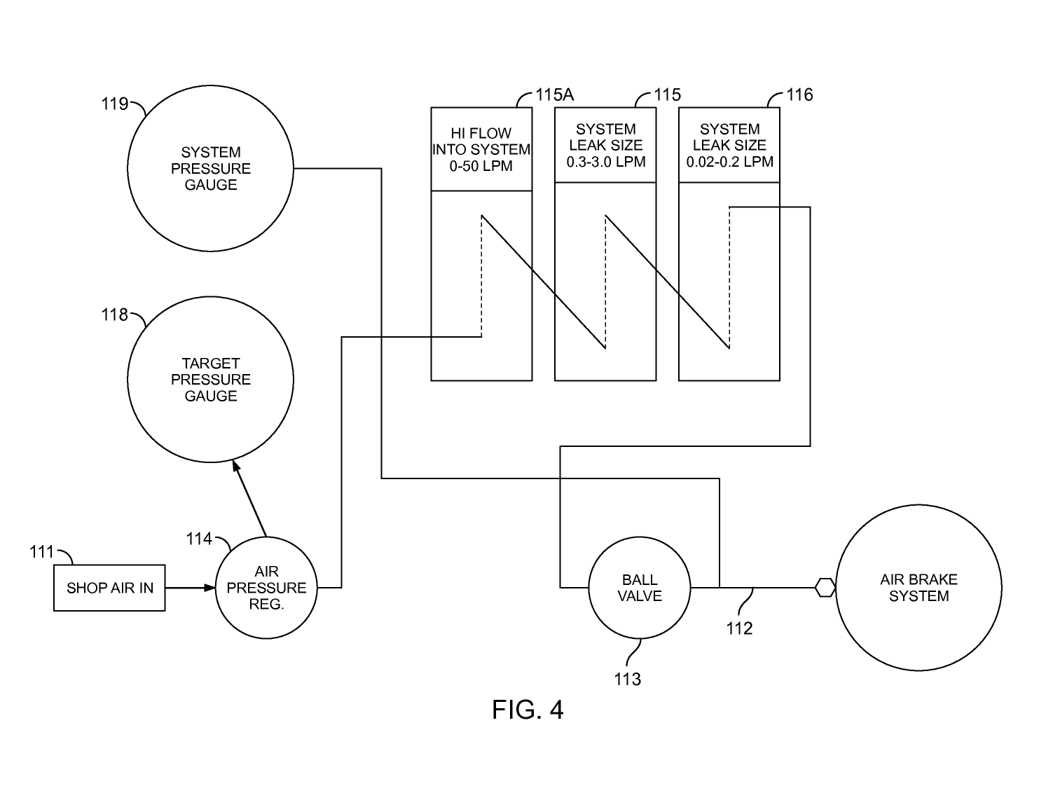

To measure leak size on an air brake system it works as follows in FIG. 4:
1) The air brake system being tested is drained of all its air pressure (this is a regularly required operation during normal service);
2) A high pressure hose 112 is inserted (from the tool) in the system after the compressor and before the dryer;
3) The ball valve 113 is closed so that the tool and the system are isolated.
4) The shop air pressure 111 is plugged into the tool;
5) The air pressure regulator 114 is turned up to the desired pressure (usually 100 psi), we're calling this target pressure and the target pressure gauge 118 will reflect that pressure;
6) The ball valve 113 is opened and shop air begins to fill the air brake system;
7) This air flow is reflected by the 3 flow meters. The hi flow 115a will indicate the speed at which the system is being filled. The two lower flow meters 115, 116 will have their indicator balls (sometimes called floats) pinned at max;
8) The system pressure gauge 119 will begin to rise, indicating approximate system pressure;
9) As the system begins to fill, the system pressure gauge will begin to close in on the target pressure gauge;
10) At the same time, the hi-flow meter indicator ball will begin to drop down as air flow gets closer to the target pressure;
11) On a vehicle that does not have any leak, eventually target & system pressure become the same and air stops flowing. At that point all 3 flow meters would have their indicator balls 25, 26 at rest (zero flow);
12) On a system with a 1 lpm leak, the flow will not stop. The hi flow meter 115a will have its indicator ball almost at rest, the 0.3-3.0 lpm meter 115 will have its indicator ball at 1 lpm and the 0.02-0.2 meter's ball 26 will be pinned high;
13) On a system with a leak over 3.0 lpm, both low flow meters will remain pinned high the hi flow meter will be very low. (a leak of this size is very large and easy to locate—it would normally be located and repaired before this test.

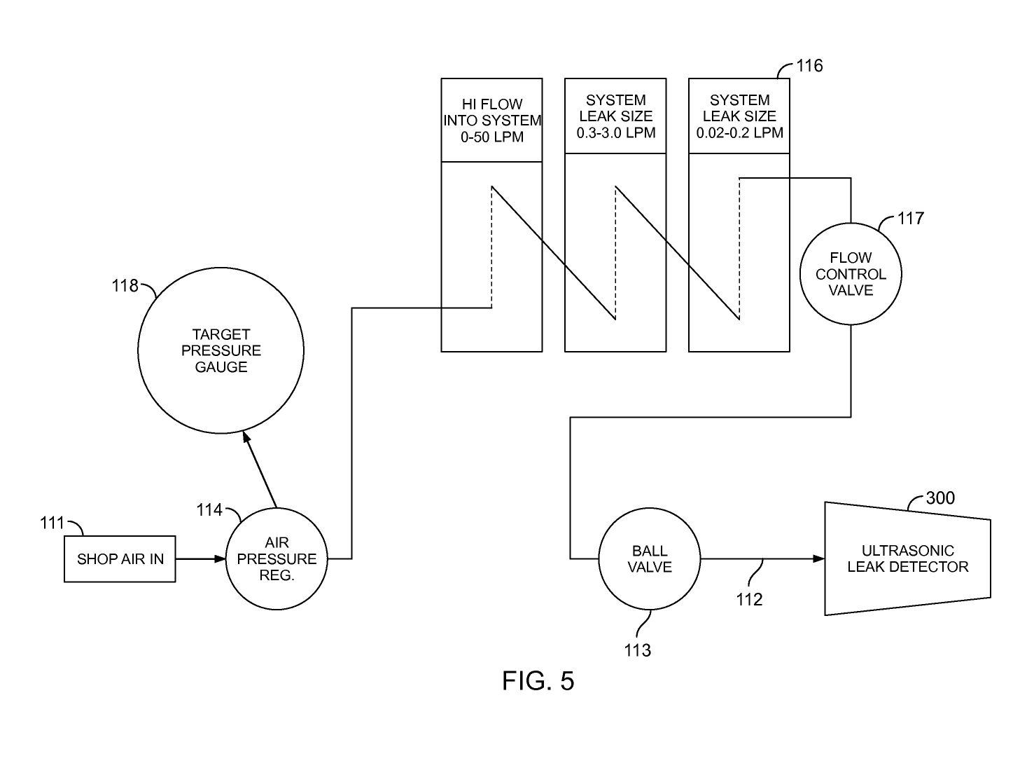

FIG. 5 shows a manner of measuring the smallest leak that any ultrasonic leak device can recognize:
1) Built into the low flow (0.02-0.2 lpm) meter is a flow control valve 117. The valve is capable of setting any limit within the flow meter's range;
2) To test a ULD 300, the flow control valve 117 is turned completely closed;
3) A fitting is plumbed into the body of the air brake solution for the purpose of testing a ULD. Air is supplied to the fitting from the System Pressure circuit;
4) The ball valve 113 is set in the closed (lock) position;
5) Shop air is hooked into the tool 111;
6) The air pressure regulator 114 is turned up until the desired target pressure (usually 100 psi) is reached;
7) The ball valve 113 is opened—there is no flow at this point as the lo flow meter flow control valve 117 is closed;
8) The ULD 300 is placed in a position facing the open test fitting;
9) The low flow meter flow control valve 117 is slowly opened until the ULD 300 responds and the flow meter reading is noted;
10) This test can be repeated from varying distances and angles to properly assess the correct minimum response from the ULD.

Once the ULD's minimum leak size capability is known, the technician will then be able to measure the leak sizes he/she is dealing with and be aware that the ULD can/can't find the leak based on its measured size and the ULD's capabilities.

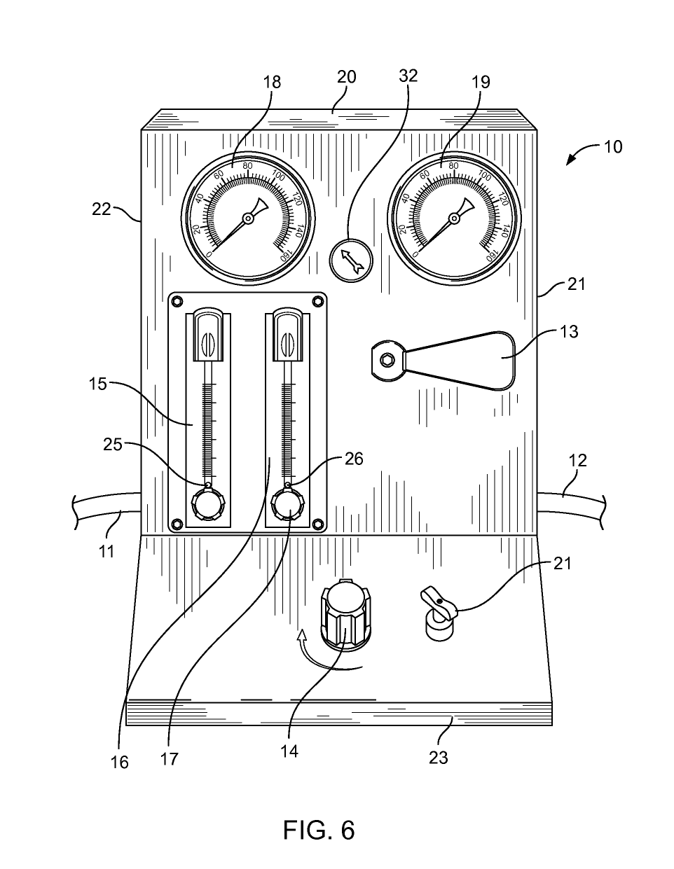

FIG. 6 illustrates one of the alternative embodiments of the invention.

This embodiment does not include the input pressure gauge to save on the cost of the unit. Further this unit comprises a reset lever 32 to release the pressure from the unit and zero the meters. Further this unit comprises a dedicated ULD test port 31. This specific port is provided to calibrate the ultrasonic devices since the release of air from the port 31 can be regulated by the low flow meter flow control valve 14. Further, this embodiment comprises a three way pilot valve to allow a by pass of the flow meters during filling of the system to the operating pressure.

Upon reaching the operating pressure, the pilot valve shifts the circuit and further supply of air to the system goes through the flow meters.

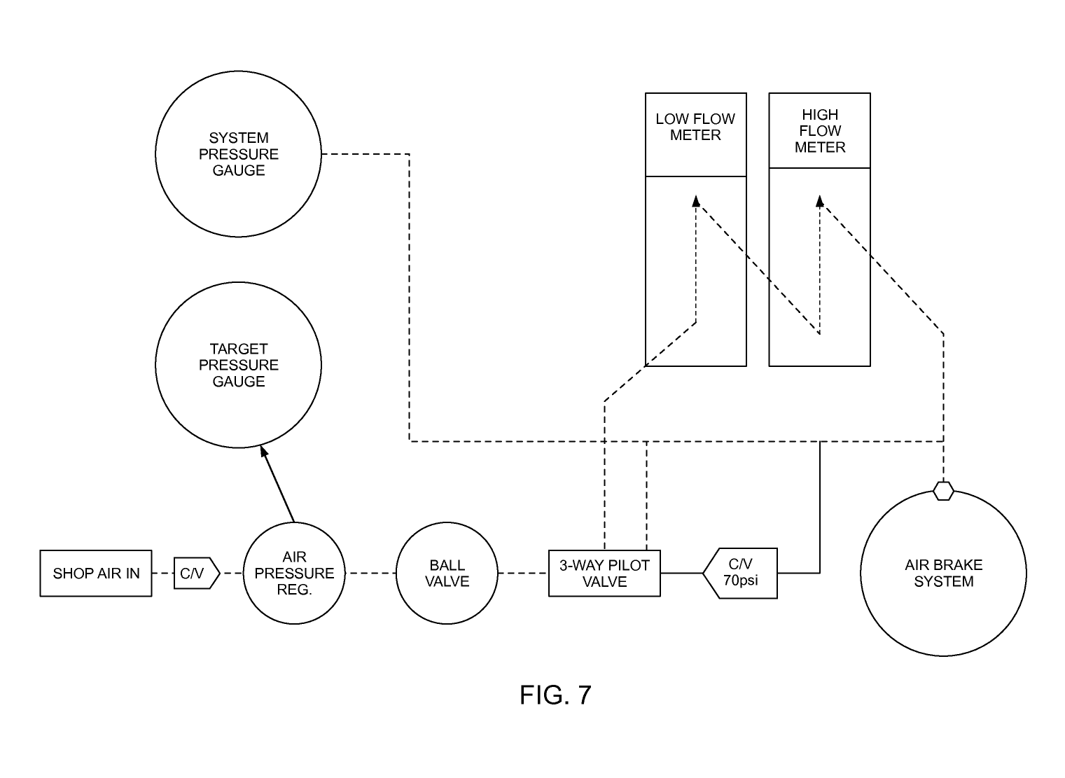

FIG. 7 schematically illustrates the tube connections in the embodiment of FIG. 6.

Shop air is being supplied through the air pressure regulator and through the ball valve to the 3-way pilot valve. When the ball valve is in open position the air flows through the pilot valve directly into the air brake system under the test. Upon reaching the pressure of 90-95 psi, the pilot valve shifts and for the rest of the test air is forced to flow through the flow meters. Upon reaching the system pressure the reading indicated on the flow meters, is an indication of an air leak in the system.

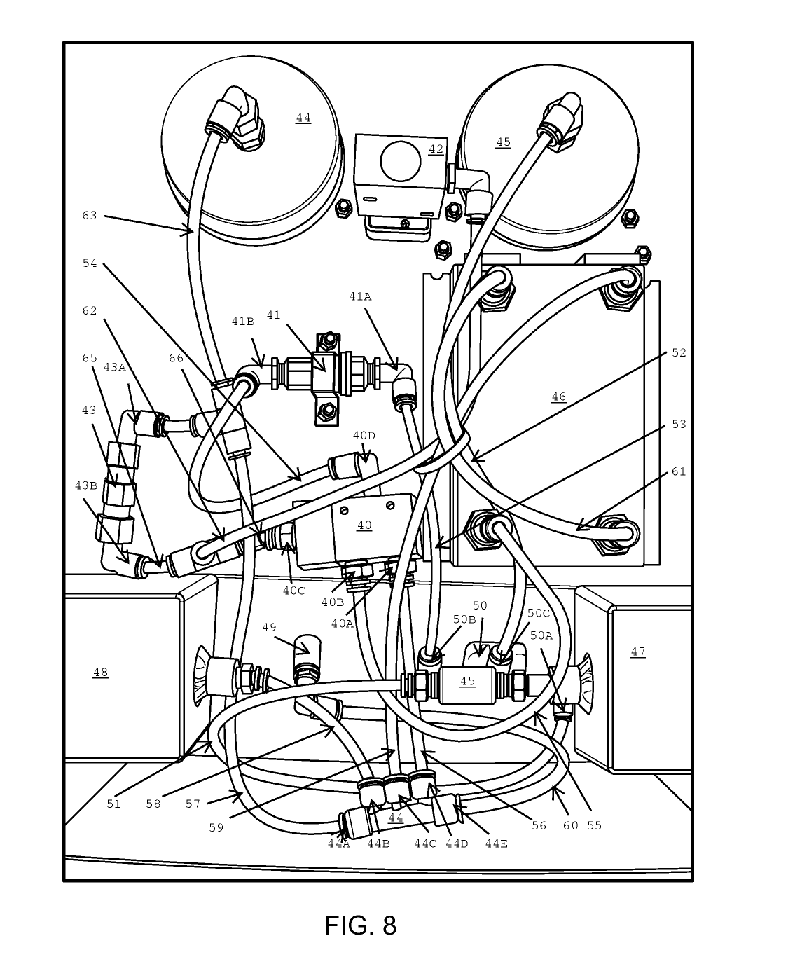

FIG. 8 Illustrates the arrangements of the tubing inside one of the embodiments of the invention illustrated in FIG. 6. The important parts in this illustration are: the pilot valve 40 and the check valve 43. The pilot valve 40 has an inlet 40D, a control port 40C and two outlet ports 40 A and 40B. While the pressure at the port 43A of the check valve 43 exceeds the check valve cracking pressure, the check valve 43 provides the actuating pressure into the control port 40C of the pilot valve 40, and switches outputs of the pilot valve from port 40A to port 40B. The operation of pilot valves and check valves are known to the person skilled in the art.

During normal test operation, air enters into the system through the inlet port 47 member 12 in FIG. 6 into check valve 45, and into the tube 51 entering a first port 50A of regulator 50. The pressure in regulator 50, is presented in the target pressure gauge 45 (member 18 in FIG. 6). The outlet 50B of regulator 50 is attached with a tube 53 to the ball valve 41 (member 13 in FIG. 6). The outlet 41B of ball valve 41 is attached with tube 54 to an inlet 40D of pilot valve 40. The pilot valve 40 in its first operating condition connects the inlet 40D to the outlet 40A with tube 56 leading to the tube splitter 44, preferably a five way tube splitter. The splitter is attached with its spout 44B to outlet 48 of the apparatus (member 11 in FIG. 6) with tube 58, and also to the system pressure gauge 44 (member 19 in FIG. 6) with tubes 57 and 63. This air continues to flow through the above-mentioned tubes until the pressure in the tested system reaches the operational pressure. The operational pressure may be in the range of 60 to 110 psi, preferably from 80 to 100 psi, more preferably about 90 psi.

Upon reaching operational pressure the check valve 43 cracks open and activates the pilot valve 40 by switching its output from outlet 40A to outlet 40B thus allowing the flow of test air through the set of flow meters 46, members 15 and 16 in FIG. 6. The air exiting the flow meters goes through tube 59 into the splitter 44 and into the tested system through outlet 48 (member 11 in FIG. 6).

During the operation of the ULD test, the outlet 48 is closed. Therefore, upon the opening of ball valve 41, the check valve 43 is cracked open, the pilot valve 40 connects it inlet 40D to the outlet 40B, and air exiting the flow meters 46 flows to splitter 44 and through tube 60 to test port 49, member 30 in FIG. 6.

The reset valve 42 (member 32 in FIG. 6) is attached with tube 62 to the line 65 exiting the check valve 43. This reset valve may be used to release the operating pressure provided to the pilot valve and return it to its first operating state in which the inlet to the pilot valve is connected to the outlet 40A.

The preferable pilot valve has just two positions and three ports plus the pilot port. That is why it's called a two position—three way valve. As well as a pilot port to shift the internal spool valve, it has an internal spring to return the valve to its normal position.

When the device of the current invention is first hooked up to a truck and the air brake system is empty, it has to be filled as fast as possible. To accomplish this, it is preferred to fill the system by-passing the flow meters, as they slow the air flow down considerably. With that in mind (see FIG. 7) the inlet air is routed through the inlet of the pilot valve and out of port A which is the normally open port. Port A flows directly into the air brake system, by-passing the flow meters. This would represent the FILLING stage of the tested system.

As the air brake system pressure passes operating pressure, preferably about 90 psi, the pilot valve shifts its output to port B, where the air flow is redirected through the flow meters so that the flow can be measured. This represents the TESTING/MEASURING stage of the system.

TESTING A ULD:

In the process of testing a ULD, the operation is exactly the same, except the outlet air hose is not used, so as soon as the ball valve is opened, the apparatus goes to full pressure and the pilot valve shifts immediately from position A to B. The low flow control valve 14 is then used in conjunction with the ULD test port 30 to emulate a leak of any size. By manipulating the two components a previously measured leak can be created and almost any ULD may be tested to prove that it can or cannot respond to a leak of the size being emulated. For example, the operator may have a ULD that is supposed to locate a leak of about 0.6 litres per minute, but the ULD in use can only find a leak of 0.75 LPM. Alternately, it may be learned that the operator needs to be within 6″ of that leak to expect a response from the ULD.

In a preferred embodiment the operational pressure is about 90 psi. To get to 30 psi to operate the pilot valve when the supply pressure is at 90 psi it should require a 60 psi check valve, which requires at least 60 psi to open and stay open. Therefore, whatever pressure is fed into/through it will drop by at least 60 psi at its outlet, regardless of the input pressure. Unfortunately, in real life, the check valve doesn't just pop wide open at 60 while it is hard to calculate the cracking pressure accurately. Therefore after substantial research, it was found that 54 psi check valve is preferred to work with 90 psi operational pressure. This check valve drops the pressure into the pilot valve down to 30 psi. It is understandable that other options for operating the pilot valve can be used for the same operation. It also should be noticed that for different systems under the test the operating pressure may vary, thus the check valve controlling the pilot valve should be adapted accordingly. For example a digital pilot valve with digital pressure meter can be used in a testing device used in various pressure systems.

The low (inlet) check valve preferably cracks at 10 psi, it mostly used to keep the air flow moving in one direction to provide steady readings on the flow meters.

The 54 psi check valve takes its inlet pressure off the same line as the system pressure gauge. It is there to feed the pilot port so that the pilot valve will shift air flow from A—direct into the air brake system by-passing the flow meters to B—through the flow meters so that we can then measure the air going through them as the air brake system pressure passes operating pressure of 90 psi.

Further in yet another embodiment of the invention analog flow meters and/or analog gauges can be replaced by digital sensors optionally equipped with a microprocessor.

As many changes can be made to the preferred embodiment of the invention without departing from the scope thereof; it is intended that all matter contained herein be considered illustrative of the invention and not in a limiting sense.

1. A leak detecting device, comprising:
a) a housing with gas inlet;
b) a gas outlet;
c) at least one pressure gauge for measuring the gas pressure supplied to the tested system;
d) at least one flow meter for measuring the flow of the gas from the leak detecting device to the tested system;
e) at least one flow control valve to vary the gas flow through the leak detecting device; and
f) an operating valve for permitting the flow of the gas from the leak detecting device into the system to be tested;
wherein when said leak detecting device is utilized, the inlet is attached to a pressure generating apparatus, the outlet is attached to the system to be tested, said at least one pressure gauge showing the system testing pressure, and the at least one flow meter indicating the flow of the gas through the leak detecting device and the system being tested, indicating the existence of any leakage and quantifying the total size of the leakage.

2. The leak detecting device of claim 1, further comprising at least two flow meters in series, wherein a first flow meter of the at least two flow meters measures high flow of gas through the leak detecting device and a second flow meter of the at least two flow meters measuring low flow of gas through the leak detecting device, wherein a volume of said leak is indicated by one of said at least two flow meters.

3. The leak detecting device of claim 2, wherein a first pressure gauge is located between the gas inlet and said at least two flow meters; and a second pressure gauge is located between the operating valve and the gas outlet from the leak detecting device, the first pressure gauge measuring the pressure provided by the pressure generating apparatus and the second pressure gauge measuring the pressure in the tested system following the opening of the operating valve.

4. The leak detecting device of claim 3, wherein during the testing procedure, the pressure generating apparatus being attached to the gas inlet to the leak detecting device, the tested system being attached to the gas outlet from the leak detecting device, thereafter the operating valve is opened and the pressure gauges are stabilized, whereby the flow meters indicate the total size of the leak in the system, the size of the leak being most acceptable if both flow meters indicate substantially zero.

5. The leak detecting device of claim 4, wherein the leak detecting device is portable, and requires no electrical input.

6. The leak detecting device of claim 1, wherein said leak detecting device is usable to determine the effectiveness of an ultrasonic leak detection device (ULD) by positioning said ULD adjacent the outlet from the leak detecting device while varying the flow control; wherein by varying the gas flow from minimal flow upward, the lower limit response of the ULD may be determined.

7. The leak detecting device of claim 6, further comprising three gas flow meters, a first gas flow measuring the range of 0 to 50 lpm, second flow meter measuring 0.3 to 3 lpm and third flow meter measuring 0.02 to 0.3 lpm.

8. The leak detecting device of claim 7, wherein the gas outlet of the leak detecting device is placed proximate an ultrasonic leak detecting device or the like; wherein the flow control valve may be varied to permit a range of gas to flow through the gas outlet, indicated by said flow meters permitting testing of the sensitivity of said ultrasonic leak measuring devices or the like in sensing a leak, by setting the flow to a known value indicated by the flow meters, thereby the lowest response point of the ULD can be determined.

9. The leak detecting device of claim 8, further comprising a dedicated ULD port connected to a pressure regulator and the flow meters, wherein the leak detecting device is used for testing of an ultrasonic leak detecting equipment.

10. The leak detecting device of claim 1, further comprising a three way pilot valve, said valve connecting the supply line to the flow meters and to the tested system, wherein the three way pilot valve allows pressurized air to bypass the flow meters during the initial fill of the tested system, while upon reaching the near operational pressure range, the three way pilot valve automatically redirects the flow to go through the flow meters, thus reducing the test time of the system.

11. The leak detecting device of claim 10, further comprising a control valve calibrated to an operational pressure of the system.

12. The leak detecting device of claim 11, wherein the operational pressure is about 54 psi check valve for about 90 psi operational pressure.

13. A method of measuring a gas leak in a pressurized system using the leak detecting device of claim 10, said leak detecting device comprising an inlet, an outlet, two pressure gauges, at least two flow meters and an operating valve and a pilot valve, the method comprising:
1) attaching the gas outlet of the device to the system being tested;
2) attaching a gas pressure generating apparatus to the gas inlet of the leak detecting device;
3) opening the operating valve to let the gas enter into the tested system bypassing the flow meters;
4) letting the pilot valve to redirect the flow to pass through the flow meters upon reaching the operational pressure in the system,
5) reading the system gas pressure on the pressure gauge;
6) allowing the pressure in the system to stabilize;
7) reading the gas flow into the system indicated on the first -high flow meter;
8) reading the gas flow into the system indicated on the second -low flow meter;
9) comparing the flow readings from the flow meters to acceptable gas leak size values;
wherein if the gas leak size is not acceptable, conducting further testing to locate the leak, using ultrasonic leak detection devices, so the appropriate repairs can be made.

14. A method of measuring a gas leak in a pressurized system using a leak detecting device, said leak detecting device comprising an inlet, an outlet, two pressure gauges, at least two flow meters and an operating valve, the method comprising:
1) attaching the gas outlet of the leak detecting device to the system being tested;
2) attaching a gas pressure generating apparatus to the gas inlet of the leak detecting device;
3) optionally reading the gas pressure supplied into the device from the first pressure gauge;
4) optionally adjusting the gas pressure supplied to the leak detecting device based on the readings of the first pressure gauge;
5) opening the operating valve to let the gas enter into the tested system;
6) reading the system gas pressure on the pressure gauge;
7) allowing the pressure in the system to stabilize;
8) reading the gas flow into the system indicated on the first -high flow meter;
9) reading the gas flow into the system indicated on the second -low flow meter; and
10) comparing the flow readings from the flow meters to acceptable gas leak size values;
wherein if the gas leak size is not acceptable, conducting further testing to locate the leak, using ultrasonic leak detection devices or the like, so the appropriate repairs can be made.

15. The method of claim 14, wherein said leak detecting device can also be used to determine the effectiveness of an ultrasonic leak detection device (ULD) by positioning said ULD adjacent the outlet from the leak detecting device while varying the flow control; wherein by varying the gas flow from minimal flow upward, the lower limit response of the ULD may be determined.
